(19) United States
(12) Patent Application Publication
(10) Pub. No.: US 2024/0229514 A9
(43) Pub. Date: Jul. 11, 2024

(54) DOOR LOCK

(71) Applicant: Dogus KOYUNCU, Copenhagen (DK)

(72) Inventor: Dogus KOYUNCU, Copenhagen (DK)

(21) Appl. No.: 18/568,859

(22) PCT Filed: Jun. 10, 2022
(86) PCT No.: PCT/TR2022/050575

§ 371 Date: Dec. 11, 2023

(30) Foreign Application Priority Data
Jun. 14, 2021 (TR) 2021/009676
Aug. 26, 2021 (TR) 2021/013482
Sep. 21, 2021 (EP) 21197962.0

(51) Int. Cl. E05B 63/16; E05B 15/00

(52) U.S. Cl. CPC E05B 63/16; E05B 15/0013

(57) ABSTRACT

A lock structure, which provides for latch bolt, which is used to open doors, to be opened independently from both sides of the door. The feature of the invention is that it comprises at least one left door handle bar receiving the motion from the left door handle, at least one right door handle bar receiving the motion from the right door handle, at least one joint, which will enable the left door handle bar and right door handle bar to move independently from each other.

### CROSS REFERENCE TO RELATED APPLICATIONS

This application is a national stage entry of International Application No. PCT/TR2022/050575, filed on Jun. 10, 2022, which is based upon and claims foreign priority to Turkey Patent Application No. TR2021/009676, filed on Jun. 14, 2021, the entire contents of which are incorporated herein by reference.

### TECHNICAL FIELD

The invention is generally related to a door lock.

The invention is particularly related to a structure that enables both sides of the door handle to move independently from each other.

### BACKGROUND

Nowadays, there are several types of door locks in use. Door locks are generally activated by a handle. The handles on both sides of the door enable the door to be opened from both inside and outside.

Door handles of the present art are rotated by a shaft, usually in the form of a square, which passes through the lock. In this process, when the door handle is rotated from one side of the door, the handle on the other side rotates automatically.

In the known state of the art, application number CN1079871C titled “Door lock device” mentions a door lock mechanism. In this patent document, it is observed that when one door handle moves, the other door handle does not move. However, the structure providing this feature is rather complex and costly.

In the known state of the art, application number CN207245388U titled “Novel safe intelligent lock” mentions a novel and safe intelligent lock mechanism. In this patent document, it is observed that when one door handle moves, the other door handle does not move. However, the structure providing this is rather complex and costly.

Consequently, constant improvements are made for the locks and therefore, new structures that will eliminate the above-mentioned disadvantages and bring about solutions to the present systems are needed.

### SUMMARY

The present invention is related a lock that meets the above-mentioned requirements, eliminates all disadvantages and brings about some additional advantages.

The main objective of the invention is to provide a simple lock structure that will ensure that when one door handle is rotated, the other door handle does not rotate.

The structural and characteristic features of the invention as well as all the advantages will be understood more clearly from the drawings in the following and the detailed description written with reference to these drawings. The evaluation should therefore be made in consideration of these drawings and the detailed description.

### BRIEF DESCRIPTION OF THE DRAWINGS

In order to better understand the structure of the present invention and its advantages with the additional elements, it should be evaluated together with the figures described below.

FIG. 1 is the isometric view of the lock as the subject of the invention.

FIG. 2 is the disassembled view of the lock as the subject of the invention.

FIG. 3 is the isometric view of the lock latch as the subject of the invention.

FIG. 4 is the front sectional view of the lock structure as the subject of the invention.

FIG. 5 is the isometric sectional view of the lock structure as the subject of the invention.

FIG. 6 is the isometric view of the lock structure as the subject of the invention.
1. Lock
2. Lock case
3. Left door handle bar
3′. Right door handle bar
3. 1 Joint
4. First latch
4′. Second latch
4. 1. First square hole
4. 2 Second square hole
5. Latch bolt
6. Knob
7. First spring
7′. Second spring
8. First washer
8′. Second washer
8″. Third washer

### DETAILED DESCRIPTION OF THE EMBODIMENTS

In this detailed description, the preferred structures of the lock as the subject of the invention are explained only for the better understanding of the subject and without any limiting effect.

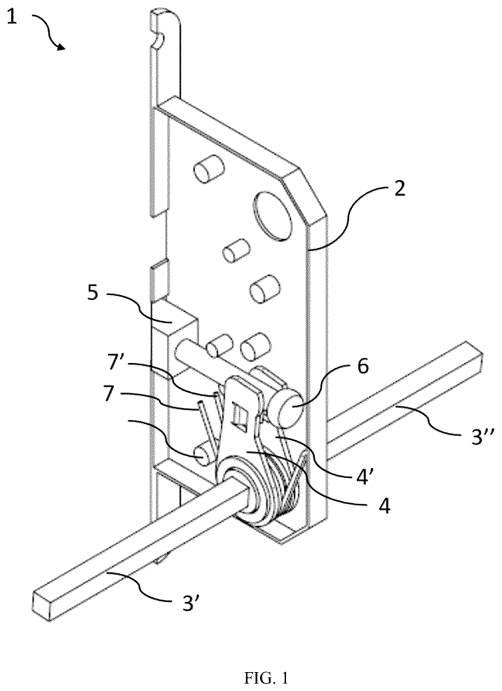

FIG. 1 is the isometric view of the lock (1) as the subject of the invention. The lock (1) is composed of the lock case (2) on the outside, other parts therein, and the handle (9) for opening the door.

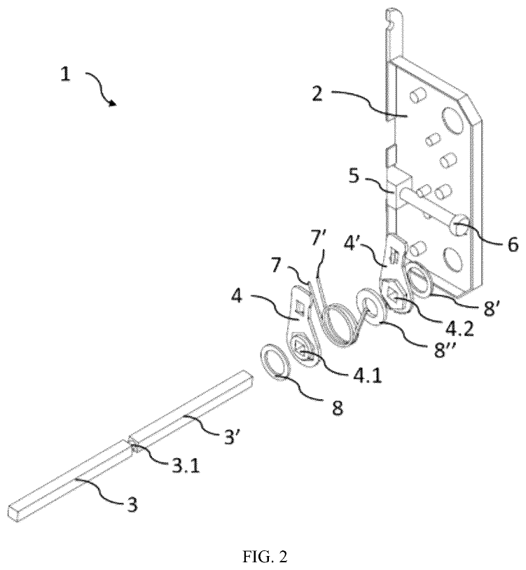

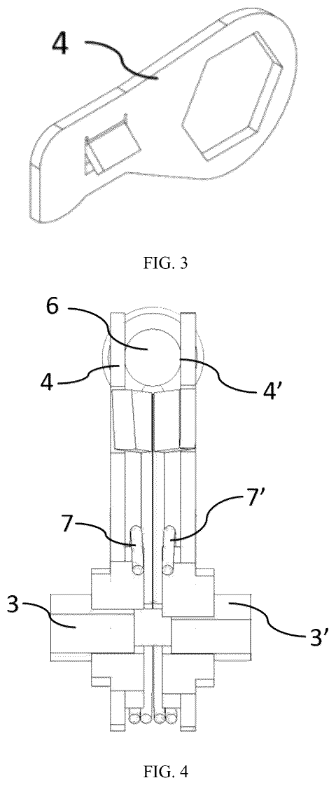

As scan be seen in FIG. 2, there are parts mounted on the lock case (2). There is a latch bolt (5) which ensures that the door is closed and opened when the handle (9) is rotated. There is a knob (6) at the other end of the latch bolt (5). The left door handle bar (3) and the right door handle bar (3′), which are passed through the lock case (2), are one piece but able to rotate independently from each other. The first latch (4) attached on the left door handle bar (3) presses on the knob (6) to move the latch bolt (5). On the other side, the second latch (4′) attached on the right door handle bar (3′) presses on the knob (6) and allows the latch bolt (5) to move. The first spring (7), which is in contact with the first latch (4), helps the first latch (4) to return to its original position. Similarly, the second spring (7′) in contact with the second latch (4′) helps the second latch (4′) to return to its original position. The first latch (8), the second washer (8′), and the third washer (8″) in the structure help to keep the distance between the parts and prevent the formation of noise by preventing the friction of the parts.

The first square hole (4.1) and the second square hole (4.2) in the structure of the first latch (4) and the second latch (4′) allow the left door handle bar (3) and the right door handle bar (3′) to pass through and this allow these latches to rotate easily. The joint (3.1) located between the left door handle bar (3) and the right door handle bar (3′) allows the left door handle bar (3) and the right door handle bar (3′) to rotate independently from each other.

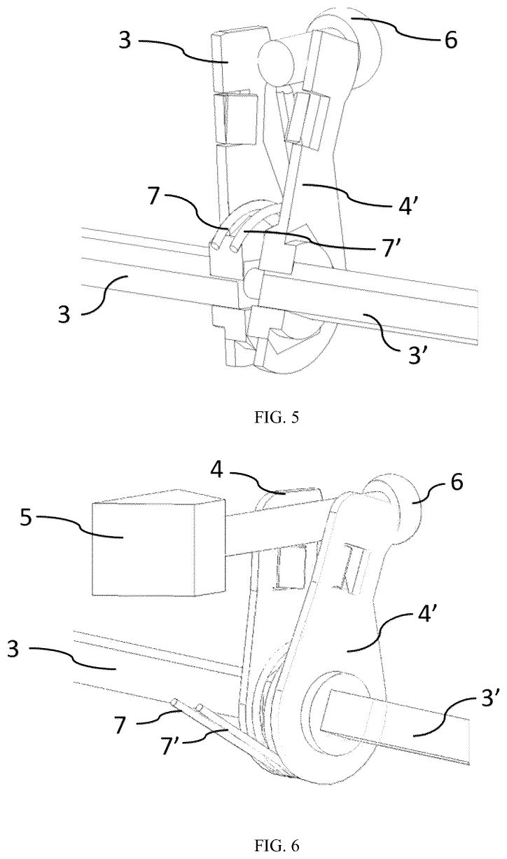

As can be seen in FIGS. 4, 5 and 6, the second latch (4′) moves with the rotation of the right door handle bar (3′). The second latch (4′) also puts pressure on the knob (6) section from its end section and enables the door to be opened by allowing the latch bolt (5) to be freed from the slot in which it is located. The second spring (7′) in the structure returns the second latch (4′) to its original position after the door is opened. In the meantime, the left door handle bar (3) on the other side of the door and the first latch (4) and first spring (7) connected to the same remain motionless.

1. A lock structure that provides for a latch bolt of a door, which is used to open the door, to be opened independently from both sides, comprising;
at least one left door handle bar that receives motion from a left door handle;
at least one right door handle bar that receives motion from a right door handle; and
at least one joint that will enable the left door handle bar and right door handle bar to move independently from each other.

2. The lock structure according to claim 1, further comprising at least one first latch that transmits rotational force coming from the left handle bar to a knob in order to move a latch bolt of the door.

3. The lock structure according to claim 2, further comprising at least one first square hole which is located on the at least one first latch and provides for a rotation with rotation movement coming from the left door handle.

4. The lock structure according to claim 2, further comprising at least one first spring that enables the first latch to come to the first latch's initial position.

5. The lock structure according to claim 1, further comprising at least one second latch that transmits rotational force coming from the right handle bar to a knob in order to move the latch bolt of the door.

6. The lock structure according to claim 5, further comprising at least one second square hole which is located on the at least one second latch and provides for a rotation with rotation movement coming from the right door handle.

7. The lock structure according to claim 5, further comprising at least one second spring that enables the second latch to come to the second latch's initial position.

8. The lock structure according to claim 3, further comprising at least one first spring that enables the first latch to come to the first latch's initial position.

9. The lock structure according to claim 6, further comprising at least one second spring that enables the second latch to come to the second latch's initial position.
